(19) United States
(12) Patent Application Publication
(10) Pub. No.: US 2009/0214901 A1
(43) Pub. Date: Aug. 27, 2009

(54) FUEL CELL SYSTEM AND CONTROL METHOD THEREOF

(75) Inventors: Junqing Dong, Guangdong (CN); Yong Zhou, Guangdong (CN)

Correspondence Address: BLAKELY SOKOLOFF TAYLOR & ZAFMAN LLP, 1279 OAKMEAD PARKWAY, SUNNYVALE, CA, 94085-4040, US

(73) Assignee: BYD COMPANY LIMITED, Guangdong (CN)

(21) Appl. No.: 12/096,872

(22) PCT Filed: Dec. 11, 2006
(86) PCT No.: PCT/CN2006/003367

§ 371 Date: Dec. 22, 2008

(30) Foreign Application Priority Data
Dec. 13, 2005 (CN) 200510130521.X

(51) Int. Cl. H01M 8/04

(52) U.S. Cl. 429/14; 429/23

(57) ABSTRACT

A fuel cell system and a control method thereof; said system comprises a fuel cell generator (5), a fuel supply unit (6), a gas supply unit (7), a detection unit (8), and a control unit (9); said detection unit (8) is for detecting the discharge parameter of said fuel cell generator (5); said control unit (9) is for controlling fuel supply from said fuel supply unit (6) and gas supply from said gas supply unit (7) in accordance with the discharge parameter detected by said detection unit (8); wherein, said detection unit (8) is a current detection device, and the discharge parameter of said fuel cell generator (5) detected by said detection unit (8) is the discharge current value. The present invention utilizes the discharge current output from the fuel cell generator as the main parameter to control the fuel/gas supply units; therefore, the control is more direct and effective. In addition, the present invention can also control the working duration of said fuel and gas supply units to operate intermittently in accordance with the said discharge current value.

### CROSS-REFERENCE TO RELATED APPLICATION

This application claims priority from Chinese Patent Application No. 200510130521.X filed on Dec. 13, 2005, the disclosure of which is incorporated herein by reference in its entirety.

### TECHNICAL FIELD

The present invention relates to a fuel cell system and the control method thereof.

### BACKGROUND

Fuel cells are devices that convert chemical energy into electric energy directly, featured with advantages including high efficiency, low pollution, and low noise, etc. Fuel cells can be individual fuel cells or fuel cell stacks comprising multiple individual fuel cells. As shown in FIG. 1, a fuel cell generally comprises proton exchange membrane 1, anode 2, cathode 3, and guide plate 4. In organic fuel cell systems, air or oxygen is usually used as the oxidant, and an organic substance such as methanol, formic acid, or alcohol is used as the fuel. For example, in a fuel cell system with air as the oxidant and methanol as the fuel, the following reactions occur during the electrochemical reactions:

Anode CH₃OH+H₂O→CO₂+6H⁺+6e (1)

Cathode 3/2O₂+6H⁺+6e→3H₂O (2)

The reactions between anode and cathode cause the following general reaction:

CH₃OH+3/2O₂→CO₂+2H₂O (3)

It is seen from the equation (1): at the anode 2, methanol diffuses through the diffusion layer to the catalyst layer and performs the electrochemical reaction to create CO₂, H⁺, and electrons. It is seen from equation (2): the electrons created at anode 2 pass through the guide plate 4 and the external conductor outside the anode 2, and finally the electrons are captured by the cathode 3. The protons created at anode 2 pass through the proton exchange membrane 1 to the cathode 3 directly, so that the current is formed.

The fuel/gas supply in existing fuel cells is mainly classified into two forms: passive and active.

The passive fuel/gas supply refers to supply fuel and oxidant gas to the two electrodes of fuel cell through fuel-supply tube and gas-supply tube by using concentration diffusion principle. However, due to the fact that the accumulated products CO₂ and H₂O produced during the reaction can't be transferred away timely, they hinder the diffusion of fuel and oxidant gas to the catalyst layer; in addition, as the reaction continues, the concentration of reactants near the reaction area becomes lower than lower, blocking diffusion of reactants and products; all of those factors make the output power of fuel cell very unstable and then the performance will be degraded. FIG. 2 is a curve chart of output voltage vs. current in the fuel cell shown in FIG. 1; and FIG. 3 is the curve chart of output power vs. time in a fuel cell stack composed of 10 stacked individual fuel cells shown in FIG. 1 in the manner of passive gas/fuel supply. It is seen from the drawings that the output power is not stable, and, as the time goes, the discharge current becomes smaller and smaller, and the power becomes lower and lower. Therefore, in order to obtain higher output power, more reactants and oxidant have to be transferred actively, i.e., active manner.

The active gas/fuel supply refers to the device that is used to transfer fuel and oxidant actively, and, more specifically, refers to add fuel pump and air compressor or fan in the fuel cell system.

For instance, patent application CN1567630A discloses a fuel cell, in which a fuel supply tube to supply fuel and a fuel return tube to recover the fuel after reaction are connected to the anode of the generator, and an air supply tube to supply air and an air exhaust tube to exhaust the air after reaction are connected to the cathode of the generator; in that fuel cell, electricity is generated by the electrochemical oxidation reaction at anode and the electrochemical reduction reaction at cathode; the performance regulating devices include: a voltmeter for measuring the output voltage of said generator and a controller for comparing the measured voltage value with the specified value and thereby detect any abnormality or for regulating the performance. Furthermore, a fuel pump for pumping fuel is mounted on the fuel supply tube and an air compressor for pumping air is mounted on the air supply tube.

Above fuel cell system and control method thereof control the supply volume of fuel and air in accordance with the voltage of the fuel cell; however, as described above, the voltage change of fuel cell is not a direct parameter that reflects the actual situation of the chemical reaction process in the fuel cell; therefore, the method of controlling fuel/air supply in accordance with the voltage of the fuel cell is apparently not directly effective enough, and can't delivery proactively control result, and thereby is not scientific.

Furthermore, above fuel cell system with active fuel/air supply and the control method thereof have two additional drawbacks: in one aspect, the external fuel pump and air compressor/fan will consume a large amount of power when they operate, resulting in low output efficiency of the fuel cell; in another aspect, the fuel pump and air compressor/fan have a very short service life under the continuous operation condition.

### SUMMARY OF THE INVENTION

In view of the drawbacks in existing fuel cell systems with active fuel/air supply and the control method thereof as described above, such as indirect and inefficient control and short service life, the present invention provides a fuel cell system with direct and effective control, high output efficiency, and long service life as well as a control method of said fuel cell system.

The inventor has found that the direct parameter that reflects the actual situation of reaction in fuel cell is the magnitude of the discharge current. It is seen from above equations (1), (2) and (3): when there is more methanol involved in the reaction at the anode 2, the discharge current output from the fuel cell is higher (i.e., more electrons are produced); however, when there is less methanol involved in the reaction at the anode 2, the discharge current output from the fuel cell is lower (i.e., fewer electrons are produced). It is obvious that the value of discharge current depends directly on the amount of reactant. Similarly, at the cathode 3, the discharge current output from the fuel cell also directly depends on the amount of the oxidant. Therefore, a fuel cell system in which the discharge current is directly associated to the fuel and air used and the control method for said fuel cell system are more direct and effective.

The fuel cell system provided in the present invention comprises: a fuel cell generator, a fuel supply unit, a gas supply unit, a detection unit and a control unit; said fuel supply unit and gas supply unit are connected to the anode inlet and cathode inlet of the fuel cell generator respectively; said detection unit is connected to the two electrodes of the fuel cell generator and is for detecting the discharge parameter of said fuel cell generator; said control unit is connected to the fuel supply unit, the gas supply unit, and the detection unit, respectively, and is for controlling fuel supply of said fuel supply unit and gas supply of said gas supply unit in accordance with the discharge parameter detected by said detection unit; wherein, said detection unit is a current detection device; said discharge parameter of the fuel cell generator detected by said detection unit is the discharge current value.

The control method for fuel cell system provided in the present invention comprises the following steps: detecting the discharge parameter of fuel cell generator in the fuel cell system; controlling fuel supply of the fuel supply unit and gas supply of the gas supply unit in accordance with the detected discharge parameter; wherein, said detected discharge parameter of the fuel cell generator is the discharge current value.

The fuel cell system and the control method thereof provided in the present invention improves the existing fuel cell systems with active fuel/gas supply and the control method thereof; it utilizes the discharge current value output from the fuel cell generator as the main discharge parameter to control the fuel supply unit/gas supply unit. Compared to the system and control method that control the fuel supply unit/gas supply unit by detecting the discharge voltage of the fuel cell generator, the fuel cell system and the control method thereof are more direct and effective in control and delivers a proactive control effect, and can avoid hindering to diffusion of the reactant and the products. The fuel cell system and the control method in a preferred embodiment of the present invention can also control the working duration within a working cycle of the fuel supply unit/gas supply unit in accordance with the discharge current, i.e., the working duration will be longer and the idle duration will be shorter if the discharge current is high; the working duration will be shorter and the idle duration will be longer if the discharge current is low. Therefore, the fuel supply unit/gas supply unit can operate intermittently; in addition, the intermittent operation can be associated to the discharge current output from the fuel cell. In that way, the fuel and oxidant can supplied as appropriate to match the discharge current; as the result, the drawback that the fuel supply unit/gas supply unit still consume a great deal energy and thereby result in inefficiency when the discharge current is small can be prevented, and the fuel cell can output stably at a higher power. Furthermore, the present invention is low in cost and easy to implement; therefore, it is of great significance to organic fuel cells for small electronic products.

### BRIEF DESCRIPTION OF THE DRAWINGS

FIG. 1 is a schematic diagram of the structural composition of an individual fuel cell;

FIG. 2 is a curve chart of output voltage vs. current of an individual fuel cell with passive fuel/gas supply;

FIG. 3 is a curve chart of output power vs. time of a fuel cell stack with passive fuel/gas supply;

FIG. 4 is a block diagram of the fuel cell system provided in the present invention;

FIG. 5 is a curve chart of the relationship between the discharge current and working duration of the fuel cell system provided in the present invention;

FIG. 6 is a flow diagram of the control method for the fuel cell system described in the present invention;

FIG. 7 shows the curve of output power vs. time of fuel cell system A in a comparative example 1;

FIG. 8 shows the curve of output power vs. time of fuel cell system B in example 1;

FIG. 9 shows the curve of output power vs. time of fuel cell system C in example 2.

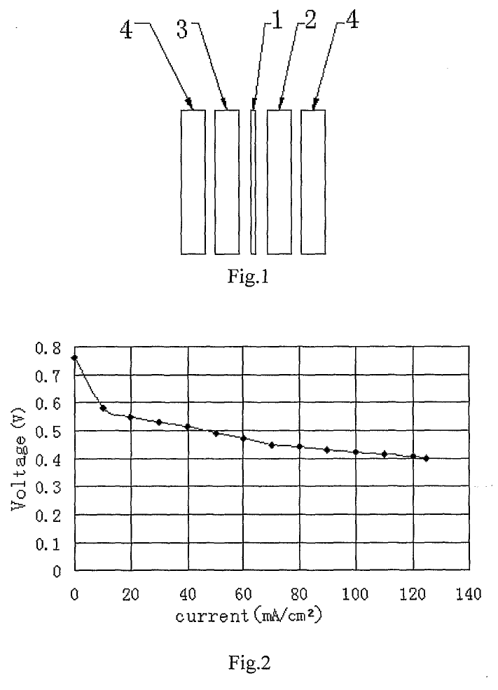

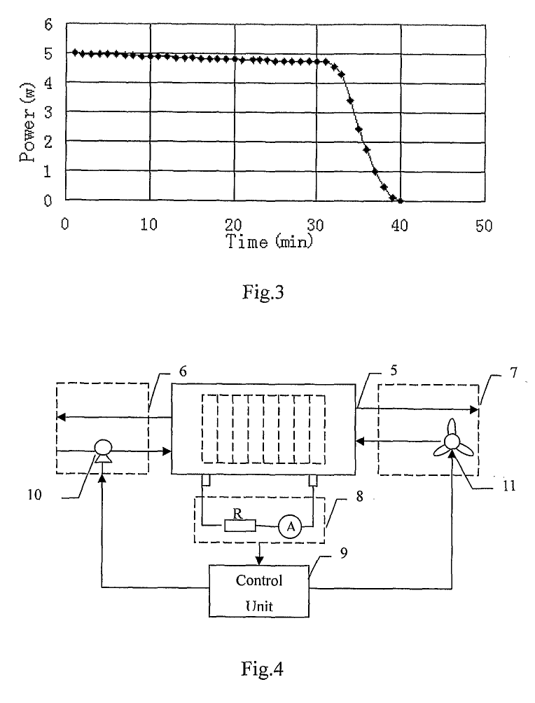

### DETAILED DESCRIPTION OF THE INVENTION

The fuel cell system and the control method provided in the present invention will be further described with reference to the accompany drawings.

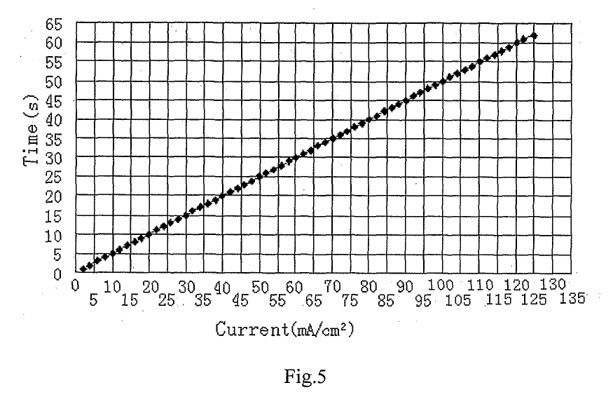

As shown in FIG. 4, the fuel cell system provided in the present invention comprises: a fuel cell generator 5, a fuel supply unit 6, a gas supply unit 7, a detection unit 8 and a control unit 9; said fuel supply unit 6 and gas supply unit 7 are connected to the anode inlet and cathode inlet of the fuel cell generator 5 respectively; said detection unit 8 is connected to the two electrodes of the fuel cell generator 5 and is for detecting the discharge parameter of said fuel cell generator 5; said control unit 9 is connected to the fuel supply unit 6, the gas supply unit 7, and the detection unit 8, respectively, and is for controlling fuel supply of said fuel supply unit 6 and gas supply of said gas supply unit 7 in accordance with the discharge parameter detected by said detection unit 8; wherein, said detection unit 8 is a current detection device; said discharge parameter of the fuel cell generator 5 detected by said detection unit 8 is the discharge current value.

Said fuel cell generator 5 is a individual fuel cell or fuel cell stack; said fuel cell stack is composed of multiple stacked individual fuel cell; said fuel cell generator 5 further comprises fuel cell reaction electrodes, electrode plates with flow channels designed to transfer oxidant gas and fuel, and current guide devices, which are comprised in conventional fuel cell generators; the structures of those devices are known to those skilled in the art.

Said fuel supply unit 6 comprises a fuel pump 10, a fuel supply tube and a fuel return tube (shown as arrowed straight lines in FIG. 4); said fuel supply tube and fuel return tube are connected to the anode inlet of said fuel cell generator 5; said fuel pump 10 is mounted on said fuel supply tube to pump fuel to said fuel cell generator 5. Said fuel pump 10 can be any pump that can drive fluids. Said fuel supply tube and fuel return tube are connected to a fuel tank (not shown) to supply and recover fuel.

Said gas supply unit 7 comprises a gas pump 11, a gas supply tube, and a gas exhaust tube (shown as arrowed straight lines in FIG. 4); said gas supply tube and gas exhaust tube are connected to the cathode inlet of said fuel cell generator 5; said gas pump 11 is mounted on the gas supply tube to pump oxidant gas to said fuel cell generator 5. Said gas pump 11 can be an air compressor or fan. Said gas supply tube is connected to a gas storage tank (not shown) or directly connected to air to supply oxidant gas; said gas exhaust tube can recover or exhaust the gas.

Said detection unit 8 can be an ohmmeter and Ampere-meter coupled in series, as shown in FIG. 4, or any device that can detect current, such as a current sensor, etc. Said detection unit 8 is connected to the discharge output end of the fuel cell generator 5 in parallel, to detect the discharge current value from said fuel cell generator 5 and send said discharge current value to the control unit 9.

Said control unit 9 comprises a signal receiver module, a time decision module, a timing module, a fuel-supply control module, and a gas-supply control module. Said signal receiver module is designed to receive the signals from the detection unit 8, determine the discharge current value in accordance with the signals, and send said discharge current value to the time decision module; said time decision module is designed to decide the scheduled working duration and scheduled idle duration in accordance with the received discharge current value, and send the two to the timing module; said timing module is designed to perform timing for the working duration and idle duration for the fuel supply unit 6/gas supply unit 7, and, if the working duration or idle duration of said fuel supply unit 6/gas supply unit 7 exceeds the scheduled working duration or scheduled idle duration, send a signal to the fuel supply control module/gas supply control module to indicate the scheduled working duration or scheduled idle duration has ended; said fuel-supply control module and gas-supply control module are designed to control fuel supply of the fuel supply unit 6 and gas supply of the gas supply unit 7 in accordance with the signal received from the timing module. Specifically, the timing module performs timing for the working duration and idle duration of fuel pump 10/gas pump 11. The fuel-supply control module and the gas-supply control module control the working state of fuel pump 10 and gas pump 11 respectively; if the fuel-supply control module/gas-supply control module receives a signal indicating the scheduled working duration has ended, the fuel-supply control module/gas-supply control module will stop the fuel pump 10/gas pump 11; if the fuel-supply control module/gas-supply control module receives a signal indicating the scheduled idle duration has ended, the fuel-supply control module/gas-supply control module will start fuel pump 10/gas pump 11.

Specifically, said time decision module decides the scheduled working duration and scheduled idle duration in accordance with the present discharge current value determined by the signal receiver module and sends the data to the timing module. Wherein, said scheduled working duration and scheduled idle duration are decided with a specific strategy, depending on the specific purpose of the fuel cell; for instance, with the curve shown in FIG. 5, the working cycle time is specified first, and then the corresponding scheduled working time is decided on the drawing in accordance with the specific discharge current value, and then the scheduled working duration is subtracted from the working cycle time to obtain the scheduled idle duration. In that way, the working duration of the fuel supply unit 6/gas supply unit 7 in a working cycle can be controlled depending on the discharge current; the higher the discharge current is, the longer the scheduled working duration will be, and the shorter the scheduled idle duration will be; the lower the discharge current is, the shorter the scheduled idle time will be, and the longer the scheduled working duration will be. Therefore, the fuel supply unit 6/gas supply unit 7 can operate intermittently and provide fuel and oxidant matching the discharge current, so as to overcome the drawback that the active electric fuel/gas supply device in fuel supply unit 6/gas supply unit 7 consumes a great deal of energy and results in inefficiency. Those skilled in the art should be aware that the precedence between working duration and idle duration in a working cycle is free, i.e., “idle” follows “working”, or “working” follows “idle”.

In above technical scheme, the time decision module can decide new scheduled working duration and new scheduled idle duration in real time in accordance with the present discharge current value; however, usually the operation of the system is controlled with the new schedule working duration and idle duration after one or several working cycles. If the present discharge current value doesn't change from the previous discharge current value, to save procedures, it is unnecessary to decide new scheduled working duration and new idle duration; instead, the entire system can still operate with the previous scheduled working duration and idle duration. In that case, said control unit 9 preferably further comprises a first current comparator module designed to judge whether the present discharge current value determined and sent by said signal receiver module is equal to the previous discharge current value, and, if the present discharge current value is different from the previous discharge current value, send the present discharge current value to the time decision module; if the present discharge current value is equal to the previous discharge current value, maintain the scheduled working duration and scheduled idle duration decided previously by the time decision module, i.e., the time decision module doesn't need to decide new scheduled working duration and new scheduled idle duration, instead, the entire system will operate in the same manner as it did in the previous working cycle.

Furthermore, if the discharge current value is equal to 0, it indicates the fuel cell generator 5 has discharged completely, and the fuel and gas supply has to be stopped. Therefore, said control unit 9 preferably further comprises a second current comparator module designed to judge whether the discharge current value determined and sent by said signal receiver module is equal to zero, and, if said discharge current value is equal to zero, notify directly said fuel-supply control module and gas-supply control module to stop fuel supply of said fuel supply unit 6 and gas supply of said gas supply unit 7; if the discharge current value is not equal to zero, send the discharge current value to said time decision module, so that said time decision module can decide the scheduled working duration and scheduled idle duration in accordance with said discharge current value.

Those skilled in the art should understand that the execution sequence between said first current comparator module and said second current comparator module can be reversed, without affecting the judgment result. For instance, whether the present discharge current value is different from the previous discharge current value can be judged first; if the present discharge current value is different, whether the present discharge current value is equal to 0 can be judged then; if the present discharge current value is equal to 0, the fuel and gas supply can be stopped; otherwise the present discharge current value is sent to the time decision module; if the present discharge current value is equal to the previous discharge current value, the previous scheduled working duration and idle duration are maintained. Or, whether the present discharge current value is equal to 0 can be judge first; if the present discharge current value is equal to 0, whether the present discharge current value is different from the previous discharge current value can be judged then; if the present discharge current value is different, the present discharge current value can be sent to the time decision module; otherwise the previously decided scheduled working duration and idle duration can be maintained.

Certainly, those skilled in the art can understand that the first current comparator module and the second current comparator module can be integrated in the signal receiver module.

Said timing module can comprise multiple timers with presetted times to perform timing for the working duration and idle duration of the fuel supply unit 6 as well as the working duration and idle duration of the gas supply unit 7, respectively. Said time decision module utilizes the decided scheduled working durations and idle durations as the presetted times for the timers, so that whenever the time counted by a timer exceeds the presetted time, the timer will send a signal indicating the scheduled working duration/scheduled idle duration has ended; whenever said signal is sent, the timer will reset to zero.

Said fuel-supply control module and gas-supply control module can control start/stop of fuel pump 10 and gas pump 11 respectively, as described above; when said fuel pump 10 and gas pump 11 start, fuel/gas will be supplied actively; when said fuel pump 10 and gas pump 11 stop, the system enter into idle mode, and fuel/gas can be supplied passively. Furthermore, the fuel supply volume from said fuel supply unit 6 and the gas supply volume from said gas supply unit 7 can also be controlled. That is to say, said fuel-supply control module and gas-supply control module can control said fuel pump 10 and gas pump 11 to supply fuel and gas at a constant rate or a variable rate. The “constant rate” refers that the supply rate of fuel/gas is constant; i.e., for electric fuel pump 10 or gas pump 11, the power is constant; the “variable rate” refers that the supply rate of fuel/gas is variable, depending on the discharge current value; i.e., the higher the discharge current value is, the higher the supply rate will be; the lower the discharge current value, the lower the supply rate will be; for electric fuel pump 10 or gas pump 11, the power is variable.

The control method for fuel cell system provided in the present invention comprises the following steps: detecting the discharge parameter of fuel cell generator 5 in the fuel cell system; controlling fuel supply of the fuel supply unit 6 and gas supply of the gas supply unit 7 in accordance with the detected discharge parameter; wherein, said detected discharge parameter of the fuel cell generator 5 is the discharge current value.

Wherein, in said method, the step that controlling the fuel supply of said fuel supply unit 6 and the gas supply of said gas supply unit 7 in accordance with the detected discharge parameter comprises the following steps: a signal receiving step, for receiving the detected discharge current value from said fuel cell generator 5 and determining said discharge current value; a time decision step, for deciding the scheduled working duration and scheduled idle duration in accordance with said discharge current value; a timing step, for timing for working duration and idle duration of said fuel supply unit 6/gas supply unit 7, and, when the working duration or idle duration of said fuel supply unit 6/gas supply unit 7 exceeds the scheduled working duration or scheduled idle duration, notifying said fuel-supply control module/gas-supply control module of the scheduled working duration or scheduled idle duration has ended; a fuel-supply control step and a gas-supply control step, for controlling fuel supply of said fuel supply unit 6 and gas supply of said gas supply unit 7 respectively in accordance with the signal indicating the scheduled working duration or scheduled idle duration has ended; specifically, controlling start/stop of said fuel pump 10 and gas pump 11. Refer to above detail description of the modules in the control unit 9 for the steps.

In the case of the control unit 9 in the fuel cell system comprises said first current comparator module, the step that controlling the fuel supply of said fuel supply unit 6 and the gas supply of said gas supply unit 7 in accordance with the detected discharge parameter in said method further comprises the following step: a first current comparison step, for judging whether the present discharge current value determined in the signal receiving step is equal to the previous discharge current value, and, if the present discharge current value is different from the previous discharge current value, deciding the scheduled working duration and scheduled idle duration in accordance with the present discharge current value in the time decision step; if the present discharge current value is equal to the previous discharge current value, maintaining the scheduled working duration and scheduled idle duration decided in the time decision step.

In the case of the control unit 9 in the fuel cell system comprises said second current comparator module, said step that controlling the fuel supply of said fuel supply unit 6 and the gas supply of said gas supply unit 7 in accordance with the detected discharge parameter in the method further comprises the following step: a second current comparison step, for judging whether the discharge current value determined in the signal receiving step is equal to 0, and, if the discharge current value is 0, notifying directly said fuel-supply control module and gas-supply control module to stop fuel supply of said fuel supply unit 6 and gas supply of said gas supply unit 7; if the discharge current value is not equal to 0, deciding the scheduled working duration and scheduled idle duration in accordance with the discharge current value in the time decision step.

Likewise, the execution sequence between said first current comparison step and said second current comparison step can be reversed, without affecting the normal operation.

In above fuel-supply control step and gas-supply control step, not only the start/stop of fuel pump 10 and gas pump 11 can be controlled, but also the fuel supply volume from said fuel supply unit 6 and the gas supply volume from said gas supply unit 7 can be controlled, i.e., the fuel pump 10 and the gas pump 11 are controlled to supply fuel and gas at a constant rate or variable rate.

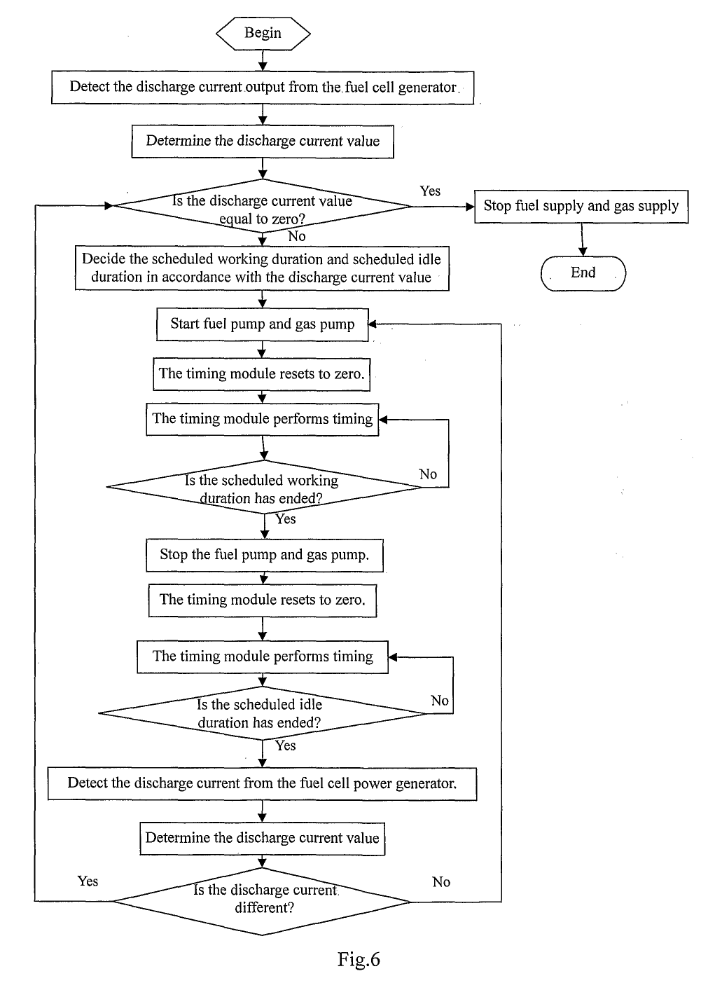

Hereunder the operation of the fuel cell system and the process flow of the control method provided in the present invention will be described, with reference to the accompanying FIG. 6. It is noted that the process flow is only an embodiment; wherein, some preferred steps can be replaced as required, for example, the execution times of the first comparison step and the second comparison step can be exchanged.

As shown in FIG. 6, first, the detection unit 8 detects the discharge current value from the fuel cell generator 5, and sends the detected signal to the signal receiver module of the control unit 9 to determine the discharge current value. Then, as shown in FIG. 6, in the second comparison step, judge whether the discharge current value is equal to 0; before the fuel cell discharges completely, i.e., the discharge current is not equal to 0, the time decision module of control unit 9 decides the scheduled working duration and scheduled idle duration in accordance with said discharge current value; for example, the durations can be determined with the curve shown in FIG. 5 or with other formulae. When the fuel cell discharges completely, the discharge current value will be 0, and the fuel supply and gas supply shall be stopped. The fuel-supply control module and gas-supply control module in control unit 9 start fuel pump 10 and gas pump 11 to supply fuel and oxidant gas actively to the fuel cell generator 5; at the same time, the timing module resets to zero and begins timing for the working duration. At the end of the scheduled working duration, the fuel-supply control module and the gas-supply control module will stop fuel pump 10 and gas pump 11; at the same time, the timing module resets to zero, and begin timing for the idle duration; once the scheduled idle duration is passed, a working cycle will end, and the discharge current is detected and the discharge current value is determined again. Now, the first comparison step can be executed to judge whether the present discharge current value is equal to the previous discharge current value; if the present discharge current value is equal to the previous discharge current value, the fuel cell system will be operate with the previously decided scheduled working duration and scheduled idle duration, i.e., the fuel-supply control module and the gas-supply control module will start the fuel pump 10 and gas pump 11 in accordance with the signal indicating the scheduled idle duration has ended; if the present discharge current value is different from the previous discharge current value, the scheduled working duration and scheduled idle duration will be redecided in the time decision module in accordance with the present discharge current value, and the above steps are repeated, till the fuel cell discharges completely, i.e., the discharge current is zero.

Therefore, it is seen that the fuel cell system provided in the present invention utilizes the control method to control the fuel supply unit 6/gas supply unit 7 to work intermittently in accordance with the discharge current value. The higher the discharge current output from the fuel cell generator 5 is, the longer the working duration of fuel pump 10 and gas pump 11 will be, and the shorter the idle duration will be, and thereby the more the fuel and oxidant gas conveyed will be; in contrast, the lower the discharge current output from the fuel cell generator 5 is, the shorter the working duration will be, and the longer the idle duration will be; therefore, the method can avoid unnecessary power consumption of fuel pump 10 and gas pump 11 and improve working efficiency.

Hereunder the invention will be further detailed in the example.

### COMPARATIVE EXAMPLE 1

The example is used to describe the existing fuel cell systems.

A fuel cell system A is constructed with reference to the fuel cell system disclosed in China patent application CN1567630A.

Wherein, the fuel cell generator is a fuel cell stack composed of 10 stacked individual fuel cell layers, with rated output power and rated current as 5 W and 125 mA, respectively. Each individual fuel cell is constructed in the structure shown in FIG. 1, with effective active area as 10 cm². A brush-less micro pump available in the market is used as the fuel pump, with 3V working current and 0.1 A working current; 2 mol/l methanol at 0.05 l/min flow rate is used as the fuel. A micro air compressor available in the market is used as the gas pump, with 3V working voltage and 0.1 A working current; air at 0.1 standard atmospheric pressure and 0.5 l/min flow rate is used as the oxidant gas. Said fuel pump and air compressor work in constant flow mode.

### EXAMPLE 1

The example is used to describe the fuel cell system provided in the present invention.

The devices are constructed as indicated in the comparative example 1; however, the difference is: a fuel cell system B is constructed as shown in FIG. 4. Wherein, the discharge current from the fuel cell generator is constant at 125 mA/cm²; the working cycle is set to 30 minutes; as indicated on the curve in FIG. 5, the scheduled working duration is 60 seconds and the scheduled idle time is 29 minutes corresponding to the current value 125 mA/cm².

### EXAMPLE 2

The example is used to describe the fuel cell system provided in the present invention.

A fuel cell system C is constructed as described in embodiment 1. However, the difference is: the discharge current from the fuel cell generator is constant at 60 mA/cm²; the working cycle is set to 30 minutes; as indicated on the curve in FIG. 5, the scheduled working duration is 30 seconds and the scheduled idle time is 29 minutes and 30 seconds corresponding to the current 60 mA/cm².

Hereunder the characteristics of the fuel cell system provided in the present invention will be described in the next example.

### EXAMPLE 3

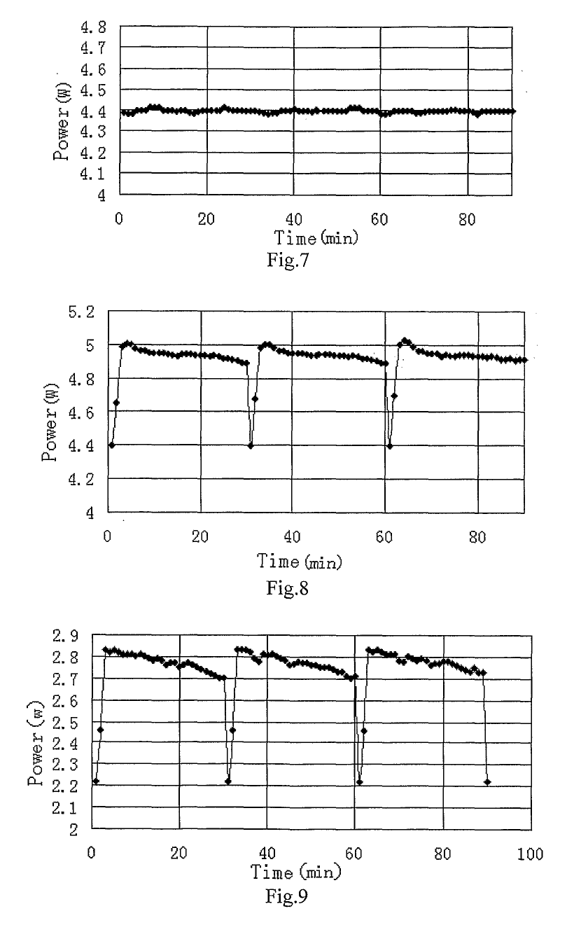

The output power of fuel cell systems A, B, and C are measured with an electronic load instrument respectively, and the curves of output power vs. time are drawn, as shown in FIGS. 7, 8, and 9 respectively.

As shown in FIG. 7, the output power of fuel cell system A is about 4.4 W, which is the net output power obtained by subtracting the power consumed by the fuel pump and the air compressor from the output power of the fuel cell generator. It is seen that though such an active fuel/gas supply approach can maintain long-time stable output, the output power is not high due to the consumption of the system itself.

As shown in FIG. 8, the output power of fuel cell system B varies by a 30 minutes cycle, and the output power is stable within the range of 4.9 W-5 W in most of the time (about 28 minutes).

Likewise, as shown in FIG. 9, the output power of fuel cell system C varies by a 30 minutes cycle, and the output power is stable within the range of 2.7 W-2.8 W in most of the time (about 28 minutes).

Therefore, it is seen from FIG. 7-9 that the fuel cell system provided in the present invention can ensure higher output power in a long time; in addition, the energy consumption is reduced because the fuel supply unit and the gas supply unit work intermittently.

1. A fuel cell system, comprising: a fuel cell generator (5), a fuel supply unit (6), a gas supply unit (7), a detection unit (8), and a control unit (9); wherein, said fuel supply unit (6) and gas supply unit (7) are connected to the anode inlet and cathode inlet of said fuel cell generator (5) respectively; said detection unit (8) is connected to the two electrodes of said fuel cell generator (5) and is for detecting the discharge parameter of said fuel cell generator (5); said control unit (9) is connected to said fuel supply unit (6), gas supply unit (7), and detection unit (8), respectively, and is for controlling fuel supply of said fuel supply unit (6) and gas supply of said gas supply unit (7) in accordance with the discharge parameter detected by said detection unit (8); wherein, said detection unit (8) is a current detection device, and the discharge parameter of said fuel cell generator (5) detected by said detection unit (8) is the discharge current value.

2. The system as in claim 1, wherein said fuel cell generator (5) is an individual fuel cell or a fuel cell stack.

3. The system as in claim 1, wherein said fuel supply unit (6) comprises a fuel pump (10), a fuel supply tube and a fuel return tube; said fuel supply tube and fuel return tube are connected to the anode inlet of said fuel cell generator (5); said fuel pump (10) is mounted on said fuel supply tube.

4. The system as in claim 1, wherein said gas supply unit (7) comprises a gas pump (11), a gas supply tube and a gas exhaust tube; said gas supply tube and gas exhaust tube are connected to the cathode inlet of said fuel cell generator (5); said gas pump (11) is mounted on said gas supply tube.

5. The system as in claim 1, wherein said control unit (9) comprises a signal receiver module, a time decision module, a timing module, a fuel-supply control module and a gas-supply control module; said signal receiver module is configured to receive the signals from said detection unit (8), determine the discharge current value in accordance with said signals, and send said discharge current value to said time decision module; said time decision module is configured to decide the scheduled working duration and scheduled idle duration in accordance with the received discharge current value and send the durations to said timing module; said timing module is configured to perform timing for the working duration and idle duration of said fuel supply unit (6)/gas supply unit (7), and, if the working duration or idle duration of said fuel supply unit (6)/gas supply unit (7) exceeds the scheduled working duration or scheduled idle duration, send a signal to the fuel-supply control module/gas-supply control module, indicating the scheduled working duration or scheduled idle duration has ended; said fuel-supply control module and gas-supply control module are configured to control fuel supply of said fuel supply unit (6) and gas supply of said gas supply unit (7) in accordance with the signal received from said timing module.

6. The system as in claim 5, wherein said timing module is configured to perform timing for the working duration and idle duration of said fuel pump (10); said fuel-supply control module is configured to control the working state of said fuel pump (10); if said fuel-supply control module receives a signal indicating the scheduled working duration has ended, it will stop said fuel pump (10); if said fuel-supply control module receives a signal indicating the scheduled idle duration has ended, it will start said fuel pump (10).

7. The system as in claim 5, wherein said timing module is configured to perform timing for the working duration and idle duration of said gas pump (11); said gas-supply control module is configured to control the working state of said gas pump (11); if said gas-supply control module receives a signal indicating the scheduled working duration has ended, it will stop said gas pump (11); if said fuel-supply control module receives a signal indicating the scheduled idle duration has ended, it will start said gas pump (11).

8. The system as in claim 5, wherein said timing module comprises multiple timers with presetted times, which are designed to perform timing for the working duration and idle duration of said fuel supply unit (6) as well as the working duration and idle duration of said gas supply unit (7); the scheduled working durations and scheduled idle durations decided by said time decision module are used as the presetted times for the timers, so that whenever the time counted by a timer exceeds the scheduled duration, an corresponding signal will be sent, indicating the scheduled working duration/scheduled idle duration has ended; whenever said signal is sent, the timer will reset to zero.

9. The system as in claim 5, wherein said control unit (9) further comprises the first current comparator module, which is configured to judge whether the present discharge current value determined and sent by said signal receiver module is equal to the previous discharge current value; and
If-the present discharge current value is judged as different from the previous discharge current value, send the present discharge current value to said time decision module;
If the present discharge current value is judged as equal to the previous discharge current value, maintain the scheduled working duration and scheduled idle duration decided previously by said time decision module.

10. The system as in claim 5, wherein said control unit (9) further comprises the second current comparator module, which is configured to judge whether the present discharge current value determined and sent by said signal receiver module is equal to zero; and
If the present discharge current value is judged as equal to zero, notify said fuel-supply control module and gas-supply control module to stop fuel supply of said fuel supply unit (6) and gas supply of said gas supply unit (7);
If the present discharge current value is judged as not equal to zero, send the present discharge current value to said time decision module.

11. A control method for fuel cell system, comprising: detecting the discharge parameter of the fuel cell generator (5) in the fuel cell system; controlling fuel supply of the fuel supply unit (6) and gas supply of the gas supply unit (7) in accordance with the detected discharge parameter; wherein, said detected discharge parameter of the fuel cell generator (5) is the discharge current value.

12. The method as in claim 11, wherein the step that, controlling the fuel supply of said fuel supply unit (6) and the gas supply of said gas supply unit (7) in accordance, with the detected discharge parameter in said method comprises the following steps: a signal receiving step, for receiving the detected discharge current value of said fuel cell generator (5) and determining the discharge current value; a time decision step, for deciding the scheduled working duration and scheduled idle duration in accordance with said discharge current value; a timing step, for timing for the working, time and idle time of said fuel supply, unit (6)/gas supply unit (7), and, if the working time or idle time of said fuel supply unit (6)/gas supply unit (7) exceeds the scheduled working duration or scheduled idle duration, notifying the fuel-supply control module/gas-supply control module of the scheduled working duration or scheduled idle duration has ended; a fuel-supply control step and a gas-supply control step, for controlling the fuel supply from said fuel supply unit (6) and the gas supply from said gas supply unit (7) respectively in accordance with the signal indicating the scheduled working duration or idle duration has ended.

13. The method as in claim 11, wherein the step that controlling the fuel supply of said fuel supply unit (6) and the gas supply of said gas supply unit (7) in accordance with the detected discharge parameter in said method further comprises the following step: a first current comparison step, for judging whether the present discharge current value determined in the signal receiving step is equal to the previous discharge current value, and, if the present discharge current value is different from the previous discharge current value, deciding the scheduled working duration and scheduled idle duration in accordance with the present discharge current value in the time decision step; if the present discharge current value is equal to the previous discharge current value, maintaining the scheduled working duration and scheduled idle duration decided previously in the time decision step.

14. The method as in claim 12, wherein the step that controlling the fuel supply of said fuel supply unit (6) and the gas supply of said gas supply unit (7) in accordance with the detected discharge parameter in said method further comprises the following step:—a second current comparison step, for judging whether the discharge current value determined in the signal receiving step is equal to zero, and, if the discharge current value is equal to zero, notifying said fuel-supply control module and gas-supply control module to stop fuel supply of said fuel supply unit (6) and gas supply of said gas supply unit (7); if the discharge current value is not equal to zero, deciding the scheduled working duration arid scheduled idle duration in accordance with said discharge current value in the time decision step.
